(19) United States
(12) Patent Application Publication
(10) Pub. No.: US 2015/0155748 A1
(43) Pub. Date: Jun. 4, 2015

(54) ROTOR FOR MODULATED POLE MACHINE

(71) Applicant: HÖGANÄS AB (PUBL), Höganäs (SE)

(72) Inventors: Göran Nord, Helsingborg (SE); Jamie Washington, Sowerby Bridge (GB)

(21) Appl. No.: 14/409,364

(22) PCT Filed: Jun. 17, 2013
(86) PCT No.: PCT/EP2013/062459

§ 371 Date: Dec. 18, 2014

(30) Foreign Application Priority Data
Jun. 20, 2012 (EP) 12172677.2

(51) Int. Cl. H02K 1/27

(52) U.S. Cl. CPC H02K 1/2786

(57) ABSTRACT

A rotor for a modulated pole machine, the modulated pole machine including a stator, the rotor, and an active gap between respective interface surfaces of the rotor and the stator for communicating magnetic flux between the stator and the rotor, the rotor being adapted to rotate relative to the stator around an axis of the rotor, and the rotor including a plurality of permanent magnets separated from each other in the circumferential direction by pole pieces; wherein each pole piece includes an interface surface facing the active air gap, wherein the interface surface of one or more of the pole pieces includes different portions having a different radial distance from the axis.

### FIELD OF THE INVENTION

This invention generally relates to modulated pole machines. More particularly, the invention relates to a rotor for such a modulated pole machine.

### BACKGROUND OF THE INVENTION

Over the years, electric machine designs such as modulated pole machines, e.g. claw pole machines, Lundell machines and transverse flux machines (TFM) have become more and more interesting. Electric machines using the principles of these machines were disclosed as early as about 1890 by W. M. Mordey and 1910 by Alexandersson and Fessenden. One of the most important reasons for the increasing interest is that the design enables a very high torque output in relation to, for instance, induction machines, switched reluctance machines and even permanent magnet brushless machines. Further, such machines are advantageous in that the coil is often easy to manufacture. However, one of the drawbacks of the design is that they are typically relatively expensive to manufacture and that they experience a high leakage flux which causes a low power factor and a need for more magnetic material. The low power factor requires an up-sized power electronic circuit (or power supply when the machine is used synchronously) that also increases the volume, weight and cost of the total drive.

Stators of modulated pole electric machines generally use of a central single winding that will magnetically feed multiple teeth formed by a soft magnetic core structure. The soft magnetic core is then formed around the winding, while for other common electrical machine structures the winding is formed around a tooth of the core section. Examples of the modulated pole machine topology are sometimes recognised as e.g. Claw-pole-, Crow-feet-, Lundell- or Transverse Flux Machines (TFM). The modulated pole machine with buried magnets is further characterised by an active rotor structure including a plurality of permanent magnets being separated by rotor pole pieces.

The TFM topology is an example of a modulated pole machine. It is known to have a number of advantages over conventional machines. The basic design of a single-sided radial flux stator is characterized by a single, simple phase winding parallel to the air gap and with a more or less U-shaped yoke section surrounding the winding and exposing in principal two parallel rows of teeth's facing the air gap. Multi-phase arrangements include magnetically separated single phase units stacked perpendicular to the direction of motion of the rotor or mover. The phases are then electrically and magnetically shifted by 120 degrees for a three-phase arrangement to smooth the operation and produce a more or less even force or torque independent of the position of the rotor or mover. Note here that the angle referred to is given in electrical degrees which is equivalent to mechanical degrees divided by the number of pairs of magnetic poles.

A cylindrical motor uses a concentric stator and rotor, and the motion is then considered as rotational or as an end-less rotation. A linear machine uses translation motion that is normally not a closed motion pattern but may be a back-and-forward motion along a ‘line’. The linear machine or driver has a mover instead of a rotor. The magnetic circuit may be arranged by the same basic magnetic principles in both a rotor and mover, however the geometries will differ.

An example of an efficient rotor or mover arrangement is the use of permanent magnets combined with soft magnetic pole pieces or pieces to allow the permanent magnet field to flux-concentrate or be flexible in a direction transverse to the motion as e.g. described in the patent application WO2007/024184 by Jack et al.

WO2007/024184 discloses an electrical, rotary machine, which includes a first stator core section being substantially circular and including a plurality of teeth, a second stator core section being substantially circular and including a plurality of teeth, a coil arranged between the first and second circular stator core sections, and a rotor including a plurality of permanent magnets. The first stator core section, the second stator core section, the coil and the rotor are encircling a common geometric axis, and the plurality of teeth of the first stator core section and the second stator core section are arranged to protrude towards the rotor. Additionally the teeth of the second stator core section are circumferentially displaced in relation to the teeth of the first stator core section, and the permanent magnets in the rotor are separated in the circumferential direction from each other by axially extending pole pieces made from soft magnetic material.

It is generally desirable to provide a modulated pole machine that is relatively inexpensive in production and assembly. It is further desirable to provide such a machine that has good performance parameters, such as one or more of the following: high structural stability, low magnetic reluctance, efficient flux path guidance, low weight, small size, high volume specific performance, etc. It is further desirable to provide components for such a machine.

An undesirable effect occurring in electrical machines is the so-called cogging torque, i.e. the torque due to the interaction between permanent magnets of the rotor and the stator. It is also known as detent or ‘no-current’ torque.

In many applications cogging has to be low due to noise and vibration requirements, as the cogging torque may cause undesired vibrations and can under certain conditions even cause undesired resonances in the apparatus comprising the electrical machine. For example, if the machine is used as a generator in a windmill the cogging torque has to be low in order to allow the generator to rotate at very low wind speeds. In case of smaller motors, up to some 50-100 Nm, cogging torque can easily be noticed by rotating the motor by hand.

In the context of a modulated pole machine (MPM), the amount of cogging torque depends on a large variety of factors. Even though some known measures for reducing cogging torque exist, cogging reduction often increases the cost of the machine since the design will be more complex. Examples of methods that add cost and complexity are skewing the rotor and/or the stator. It is thus desirable to reduce the cogging of a modulated pole machine while avoiding an increase in machine complexity and/or cost. It is further desirable to provide a machine that can be manufactured efficiently and at low cost.

### SUMMARY

According to a first aspect, disclosed herein is a rotor for a modulated pole machine, the modulated pole machine comprising a stator, the rotor, and an active gap between respective interface surfaces of the rotor and the stator for communicating magnetic flux between the stator and the rotor, the rotor being adapted to rotate relative to the stator around an axis of the rotor, and the rotor comprising a plurality of permanent magnets separated from each other in the circumferential direction by pole pieces; wherein each pole piece comprises an interface surface facing the active gap, wherein the interface surface of one or more of the pole pieces comprises different surface portions having different respective radial distances from the axis.

Hence, disclosed herein are embodiments of a rotor for a modulated pole machine whose components can be efficiently produced and that reduces the cogging torque of the machine. In particular, embodiments of the pole pieces herein are well-suited for production by Powder Metallurgy (P/M) production methods. More particular, as the elevated portions only need to have a very limited height and as the elevated portions are raised in the direction of the punch, the elevated portions may easily be provided by a modification of the shape of the upper punch. In particular, as the pole pieces have a relatively simple geometry and the required modifications are simple, e.g. compared to the stator core sections of the stator, a modification of the shaping process and tools is easy and inexpensive.

In some embodiments, the interface surface comprises an elevated portion having a first distance to the axis and a low portion having a second distance to the axis, different from the first distance, and where the elevated portion is elevated from the low portion relative to a centre of the pole piece. The low portion may be a base surface that may be a part of a cylindrical surface having a radius equal to the distance from the low portion to the axis. Hence, the low portion may have a uniform distance to the axis. Similarly, each elevated portion may be a part of a cylindrical surface having a radius equal to the distance from the elevated portion to the axis, i.e. each elevated portion may have a uniform distance to the axis. Generally, in the assembled machine, the elevated portion has a smaller distance to the stator than the low portion.

Normally the pole piece may be manufactured as a one-level component; only if the elevation of the elevated portions exceeds a certain threshold, e.g. 0.2 mm, may an extra punch level be desirable. Consequently, the shaping of the pole pieces can be made without significantly increasing the manufacturing cost or complexity of the resulting machine. Furthermore, a modification of the other motor components, e.g. the stator, is not required. The height difference between the low and elevated portions may depend on the dimensions of the rotor. In general the height difference will not be higher than the active air gap. The height difference may be uniform across each elevated portion or it may vary across one or more of the elevated portions.

Hence, in some embodiments, the elevated portion has a height relative to the low portion which height varies along the circumferential direction of the rotor. In one embodiment the height has a maximum and decreases in the circumferential direction towards the edges of the pole piece.

According to some embodiments, an average radial distance from the interface surface to the axis, averaged along an axial direction along the pole piece, varies in the circumferential direction of the rotor.

According to some embodiments, an average radial distance from the interface surface to the axis, averaged along a circumferential direction of the pole piece, varies in the axial direction of the rotor.

According to some embodiments, a cross section of the pole piece normal to the axial direction defines a profile of the interface surface. In some embodiments, the profile is different from a straight line and/or different from an arc of a circumference of a cylinder.

According to some embodiments, each pole piece is an elongated rod elongated in the axial direction of the rotor, and having a first side face defining the interface surface.

The present invention relates to different aspects including the rotor described above and in the following, and corresponding methods, devices, and/or product means, each yielding one or more of the benefits and advantages described in connection with the first mentioned aspect, and each having one or more embodiments corresponding to the embodiments described in connection with the first mentioned aspect and/or disclosed in the appended claims. In particular the present invention relates to a modulated pole machine comprising such a rotor.

According to a second aspect, in addition to or alternative to the shaping of the interface surface of the pole pieces described herein, the cogging torque may also be reduced by providing the rotor with pole pieces having different respective widths, measured in the direction of motion of the rotor. For example, the rotor may comprise a first set of pole pieces having a first width and a second set of pole pieces having a second width larger than the first width. The pole pieces of the first and second set may be arranged alternatingly along the direction of motion of the rotor such that each permanent magnet has adjacent to it a pole piece of the first set and a pole piece of the second set.

The interface surface may be shaped such that the width of the active gap changes gradually when a pole piece during operation of the modulated pole machine passes an interface surface of the stator, e.g. as defined by a tooth of the stator protruding towards the rotor. In particular, in some embodiments the elevated portions may have a width measured in the circumferential direction that varies along the axial direction. For example, the elevated portion may have a shape (when viewed in the radial direction) that is triangular, has the form of a parallelogram, or the like. In other embodiments, the elevated portion has a height relative to the low portion which height varies along the circumferential direction of the rotor.

In some embodiments, a radial-circumferential cross section of the interface surfaces of the pole pieces follows a curve having a periodically varying radial distance from the centre, thus allowing higher harmonics of the cogging torque to be reduced.

The active gap is often also referred to as an air gap, as it is normally filled with air.

In embodiments of the modulated pole machine, the pole pieces are formed as rectilinear rods elongated in the axial direction of the rotor. The plurality of permanent magnets may be arranged so that the direction of magnetisation alternate around the circumference. Generally, the permanent magnets may be rectilinear rods elongated in the transverse direction; the rods may extend across the transverse extent of the active air gap.

Embodiments of a stator of the modulated pole machine comprise one, two or more stator core sections. Each stator core section may comprise a stator core back section and a set of teeth extending from the stator back core section towards the rotor, wherein the stator core back section connects the teeth. A stator core section may further comprise a yoke section that provides a flux path in the lateral direction towards another stator core section comprising another one of the sets of teeth of the same phase. The core back section and the yoke section provide a flux path between neighboring teeth of the respective stator core sections. The teeth of the respective stator core sections may be displaced with respect to each other in the circumferential direction. In some embodiments, the stator comprises a winding arranged between the first and second stator core sections. The teeth of two stator core sections may thus form respective circumferential rows of teeth where the rows are axially spaced apart and separated by the winding of the stator, the coil/winding being accommodated in a circumferentially extending gap between the rows of teeth.

In some embodiments, the stator core section and/or the pole pieces of the rotor are made from a soft magnetic material such as soft magnetic powder, thereby simplifying the manufacturing of the components of the modulated pole machine and providing an efficient magnetic flux concentration, utilizing the advantage of effective three-dimensional flux paths in the soft magnetic material allowing e.g. radial, axial and circumferential flux path components in a rotary machine.

The soft magnetic powder may e.g. be a soft magnetic Iron powder or powder containing Co or Ni or alloys containing parts of the same. The soft magnetic powder could be a substantially pure water atomised iron powder or a sponge iron powder having irregular shaped particles which have been coated with an electrical insulation. In this context the term “substantially pure” means that the powder should be substantially free from inclusions and that the amount of the impurities O, C and N should be kept at a minimum. The average particle sizes are generally below 300 μm and above 10 μm.

However, any soft magnetic metal powder or metal alloy powder may be used as long as the soft magnetic properties are sufficient and that the powder is suitable for die compaction.

The electrical insulation of the powder particles may be made of an inorganic material. Especially suitable are the type of insulation disclosed in U.S. Pat. No. 6,348,265 (which is hereby incorporated by reference), which concerns particles of a base powder consisting of essentially pure iron having an insulating oxygen- and phosphorus-containing barrier. Powders having insulated particles are available as Somaloy® 500, Somaloy® 550 or Somaloy® 700 available from Hoganas AB, Sweden.

The shaping of the pole pieces including the elevated portions of the interface surface may thus efficiently be implemented by compacting the pole piece from soft magnetic powder in a suitable compacting tool, such as a tool using a so-called shaped die.

The stator core sections, the coil and the rotor encircle a common geometric axis. In a rotary machine the transverse direction is an axial direction of the machine, and the direction of motion is a circumferential direction of the machine.

In some embodiments, the stator comprises: a first stator core section being substantially annular and including a plurality of teeth, a second stator core section being substantially annular and including a plurality of teeth, a coil arranged between the first and second circular stator core sections, wherein the first stator core section, the second stator core section, the coil and the rotor are encircling a common geometric axis defined by the longitudinal axis of the rotor, and wherein the plurality of teeth of the first stator core section and the second stator core section are arranged to protrude towards the rotor; wherein the teeth of the second stator core section are circumferentially displaced in relation to the teeth of the first stator core section.

In conventional machines, the coils explicitly form the multi-pole structure of the magnetic field, and the magnetic core function is just to carry this multi-pole field to link the magnet and/or other coils. In a modulated pole machine, it is the magnetic circuit which forms the multi-pole magnetic field from a much lower, usually two, pole field produced by the coil. In a modulated pole machine, the magnets usually form the matching multi-pole field explicitly but it is possible to have the magnetic circuit forming multi-pole fields from a single magnet. The modulated pole machine has a three-dimensional (3D) flux path utilizing magnetic flux paths in the axial direction both in the stator and in the rotor. Thus in some embodiments the stator device and/or the rotor provide a three-dimensional (3D) flux path including a flux path component in the transverse direction relative to the direction of motion.

In some embodiments, the modulated pole machine is a multi-phase machine having two outer phases and one or more central phases, each phase comprising a coil axially sandwiched between respective circumferential rows of radially protruding teeth; wherein the portions of the interface surface of the rotor pole pieces at axial positions of the teeth are elevated from the portions of the interface surface at axial positions of the coils. Alternatively or additionally, the portions of the interface surface at axial positions of the teeth are elevated from the portions of the interface surface at axial positions between adjacent rows of teeth of respective phases. Hence, the distance between the rotor pole piece and the stator is radially larger at axial positions where there is a coil or gap under the pole piece, thus reducing undesirable ‘leakage’ fluxes in the rotor and a reducing the mutual inductances between phases.

In some embodiments, the modulated pole machine is a multi-phase machine having two outer phases and one or more central phases; wherein the portions of the interface surfaces at positions of the outer phases are elevated from the portions of the interface surface at positions of the central phase, thus causing the active gap of the central phase to be wider than the active gap of the outer phases. It is an advantage of embodiments of the rotor described herein that counter electromotive forces may be reduced in a cost efficient manner.

### BRIEF DESCRIPTION OF THE DRAWINGS

The above and/or additional objects, features and advantages of the present invention, will be further elucidated by the following illustrative and non-limiting detailed description of embodiments of the present invention, with reference to the appended drawings, wherein:

FIG. 1 shows an example of a single-phase modulated pole machine.

FIG. 2 shows a schematic view of an example of a stator for a modulated pole machine.

FIG. 3 shows a 3-phase modulated pole machine comprising a stator with 3 sets of stator component pairs, each holding one circumferential winding.

FIG. 4 shows examples of rotor pole pieces for a rotor of a modulated pole machine.

FIG. 5 shows cross sections of parts of examples of rotors for a modulated pole machine.

FIG. 6 shows another example of a rotor for a modulated pole machine.

FIG. 7 schematically illustrates an example of a tool for manufacturing rotor pole pieces and stator core sections as described herein.

FIGS. 8a-f schematically illustrate an example of the pressing process for manufacturing rotor pole pieces and stator core sections as described herein.

FIG. 9 shows examples of a 3-phase MPM cogging torque shape without cogging reduction and with different types of cogging torque reduction.

FIG. 10 shows a 3-phase modulated pole machine comprising a stator with 3 sets of stator component pairs, each holding one circumferential winding.

FIG. 11 shows further examples of rotor pole pieces for a rotor of a modulated pole machine.

### DETAILED DESCRIPTION

In the following description, reference is made to the accompanying figures, which show by way of illustration how the invention may be practiced.

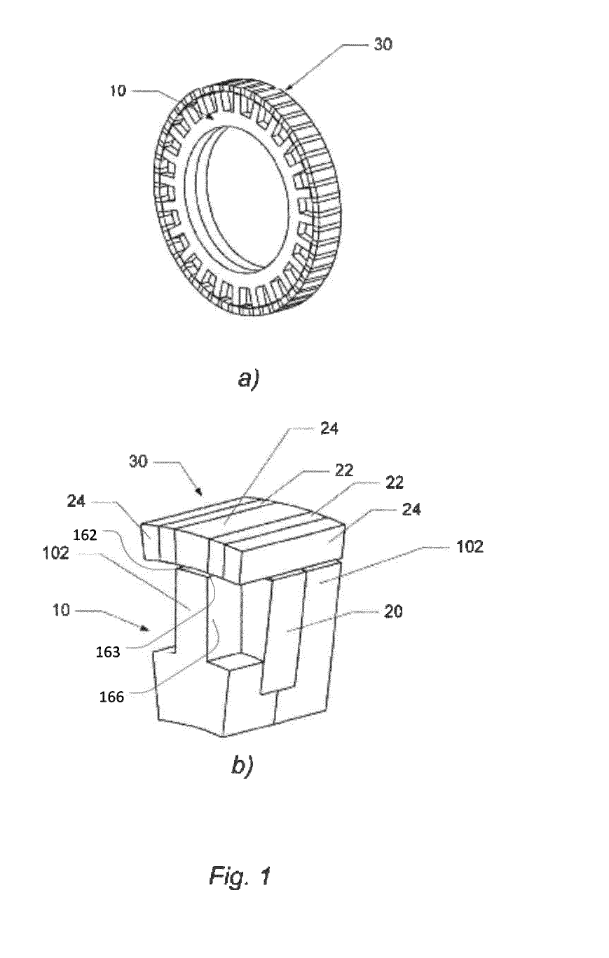

FIG. 1 illustrates an example of a modulated pole machine. In particular, FIG. 1 shows the active parts of a single phase, e.g. a one-phase machine or a phase of a multi-phase machine. FIG. 1a shows a perspective view of the active parts of the machine including a stator 10 and a rotor 30. FIG. 1 b shows an enlarged view of a part of the machine.

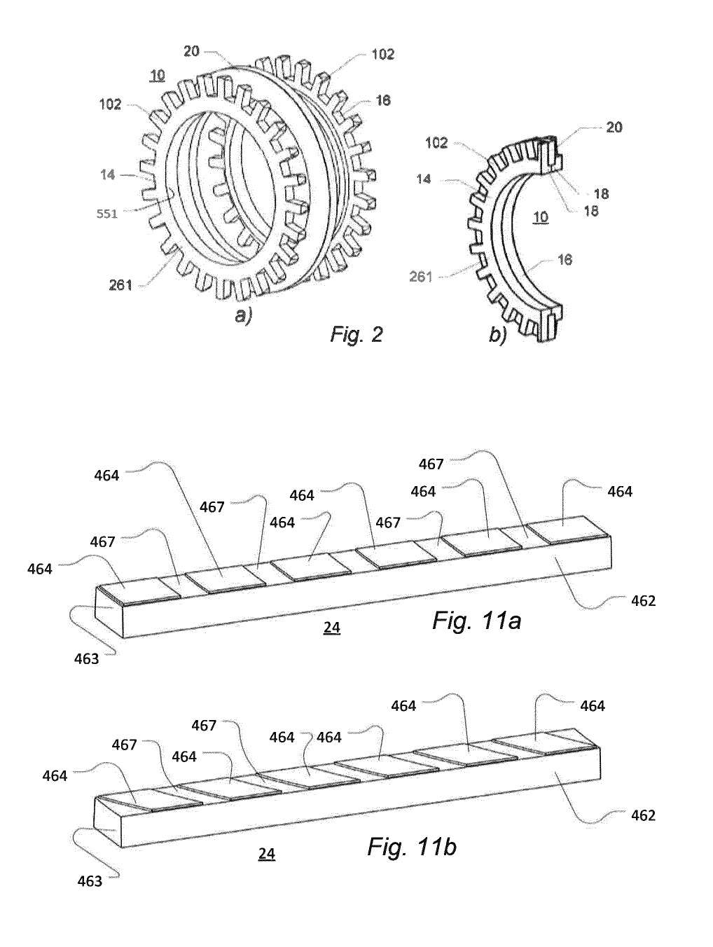

FIG. 2 illustrates an example of the stator 10 of the modulated pole machine of FIG. 1. In particular, FIG. 2a shows an exploded view of the stator 10, illustrating two stator core sections 14, 16, and a winding 20. FIG. 2b shows a cut-view of the stator 10.

The machine comprises a stator 10 which comprises a central single winding 20 that magnetically feeds multiple teeth 102 formed by a soft magnetic stator core structure. The stator core is formed sandwiched around the winding 20 while for other common electrical machine structures the winding is formed around the individual teeth of the stator core section. More particularly the modulated pole electric machine of FIGS. 1 and 2 comprises two stator core sections 14, 16 each including a plurality of teeth 102 and being substantially annular, a winding 20 arranged between the first and second annular stator core sections, and a rotor 30 including a plurality of permanent magnets 22. Further, the stator core sections 14, 16, the coil 20 and the rotor 30 encircle a common geometric axis, and the plurality of teeth 102 of the two stator core sections 14, 16 are arranged to protrude towards the rotor 30 for forming a closed circuit flux path. The stator teeth of the two stator core sections 14, 16 are circumferentially displaced in relation to each other.

Each stator core section comprises an annular core back portion 261 and a flux bridge or yoke component 18 providing a flux path between circumferentially displaced teeth of the two stator core sections. In the machine in FIGS. 1 and 2 the stator teeth protrude in a radial direction towards the rotor, in this case with the rotor surrounding the stator. However, the stator could equally well be placed exteriorly with respect to the rotor. Embodiments of the rotor and the stator described herein may be used in single and/or in multi-phase machines. Similarly, embodiments of the rotor and the stator described herein may be used in inner and outer rotor machines.

The active rotor structure 30 is built up from an even number of segments 22, 24 wherein half of the number of segments—also called rotor pole pieces 24—are made of soft magnetic material and the other half of the number of segments are made of permanent magnetic material 22. These segments may be produced as individual components. The permanent magnets 22 are arranged so that the magnetization directions of the permanent magnets are substantially circumferential, i.e. the north and the south poles, respectively, face in a substantially circumferential direction. Further, every second permanent magnet 22, counted circumferentially is arranged having its magnetization direction in the opposite direction in relation to its neighbouring permanent magnets. The magnetic functionality of the soft magnetic pole pieces 24 in the machine structure is fully three dimensional and each soft magnetic pole piece 24 is able to efficiently carry varying magnetic flux with high magnetic permeability in all three space directions.

This design of the rotor 30 and the stator 10 has the advantage of enabling flux concentration from the permanent magnets 22 so that the surface of the rotor 30 facing a tooth of the stator 10 may present the total magnetic flux from both of the neighboring permanent magnets 22 to the surface of the facing tooth. The flux concentration may be seen as a function of the area of the permanent magnets 22 facing each pole piece 24 divided with the area facing a tooth. In particular, due to the circumferential displacement of the teeth, a tooth facing a pole piece results in an active air gap that only extends partly across the axial extent of the pole piece. Nevertheless, the magnetic flux from the entire axial extent of the permanent magnets is axially and radially directed in the pole piece towards the active air gap. These flux concentration properties of each pole piece 24 make it possible to use weak low cost permanent magnets as permanent magnets 22 in the rotor and makes it possible to achieve very high air gap flux densities. The flux concentration may be facilitated by the pole piece being made from magnetic powder enabling effective three dimensional flux paths. Further, the design also makes it possible to make more efficient use of the magnets than in corresponding types of machines.

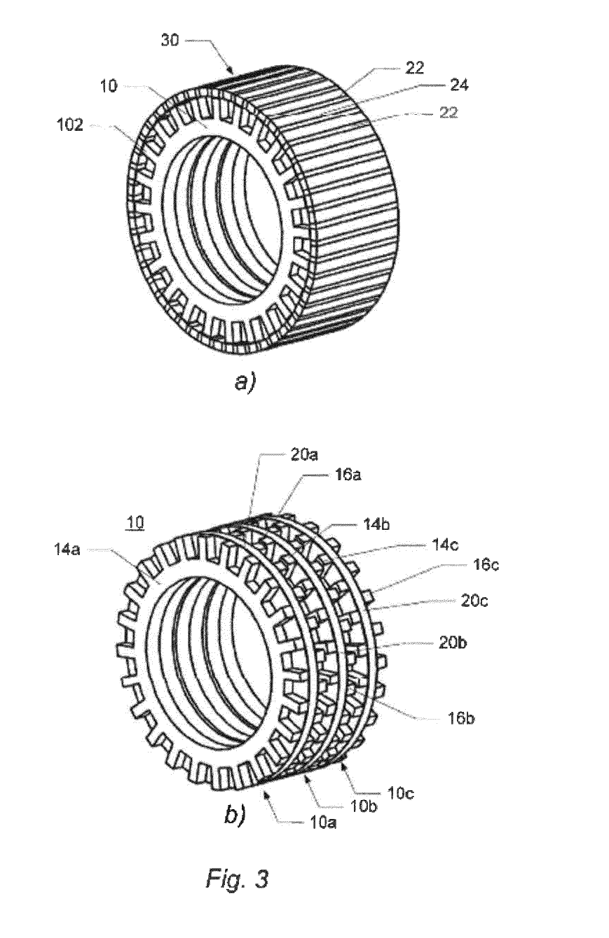

Still referring to FIGS. 1 and 2, the single-phase stator 10 may be used as a stator of a single-phase machine as illustrated in FIGS. 1 and 2, and/or as one phase of a multi-phase machine, e.g. one of the stator phases 10a-c of the machine of FIG. 3. The stator 10 comprises two identical stator core sections 14, 16, each comprising a number of teeth 102. Each stator core section is made of soft magnetic powder, compacted to shape in a press tool. When the stator core sections have identical shapes, they may be pressed in the same tool. The two stator core sections are then joined in a second operation, and together form the stator core with radially extending stator core teeth, where the teeth of one stator core section are axially and circumferentially displaced relative to the teeth of the other stator core section.

Each of the stator core sections 14, 16 may be compacted in one piece. Each stator core section 14, 16 may be formed as an annular disc having a central, substantially circular opening defined by a radially inner edge 551 of an annular core back portion 261. The teeth 102 protrude radially outward from a radially outer edge of the annular disc-shaped core back. The annular part between the inner edge 551 and the teeth 102 provides a flux path and a side wall of a circumferential cavity accommodating the coil 20. Each stator core section comprises a circumferential flange 18 at or near the inner edge 551. In the assembled stator the circumferential flange 18 is arranged on the inner side of the stator core section, i.e. the side facing the coil 20 and the other stator core section. In the embodiment shown in FIGS. 1 and 2, the stator core sections 14, 16 are formed as identical components. In particular both stator core sections comprise a flange 18 protruding towards the respective other stator core section. In the assembled stator, the flanges 18 abut each other and form an axial flux bridge allowing the provision of an axial magnetic flux path between the stator core sections. In the assembled stator for an outer rotor machine the coil thus encircles the stator core back formed by flanges 18.

Each of the teeth 102 has an interface surface 162 facing the air gap. During operation of the machine, the magnetic flux is communicated through the interface surface 162 via the air gap and through a corresponding interface surface of a pole piece of the rotor. The interface surface 162 is delimited in the circumferential direction, i.e. along the direction of motion of the rotor, by edges 163. Hence, the edges 163 connect the interface surface 162 with the respective side faces 166 of the tooth that face the neighbouring teeth.

FIG. 3a illustrates an example of a 3-phase modulated pole machine, while FIG. 3b shows an example of a stator of the machine of FIG. 3a. The machine comprises a stator 10 and a rotor 30. The stator 10 contains 3 stator phase sections 10a, b, c each as described in connection with FIGS. 1 and 2. In particular each stator phase section comprises a respective stator component pair 14a, 16a; 14b, 16b; and 14c, 16c, respectively, each holding one circumferential winding 20a-c, respectively.

Hence, as in the example of FIGS. 1 and 2, each electric modulated pole machine stator phase section 10a-c of FIG. 3 comprises a central coil 20a-c, e.g. a single winding, that magnetically feeds multiple teeth 102 formed by the soft magnetic core structure. More particularly, each stator phase 10a-c of the shown electric modulated pole machine comprises two stator core sections 14, each including a plurality of teeth 102 and being substantially annular, a coil 20 arranged between the first and second circular stator core sections. Further, the stator core sections 14 and the coil 20 of each stator phase encircle a common axis, and the plurality of teeth 102 of the stator core sections 14 are arranged to protrude radially outward. In the example of FIG. 3 the rotor 30 is arranged coaxially with the stator 10 and encircling the stator so as to form an air gap between the teeth 102 of the stator and the rotor. The rotor may be provided as alternating permanent magnets 22 and pole pieces 24 as described in connection with FIGS. 1 and 2, but axially extending across all stator phase sections, i.e. a single rotor structure is provided serving all three phases. It will be appreciated, however, that in other embodiments the rotor may be provided as three separate cylindrical rotors arranged in axial extension from each other. In yet other embodiments some or all of the rotor components, e.g. the permanent magnets 22 may be provided as a series of shorter components, each having the axial extent of a single phase only.

The embodiments of the stator described in connection with FIGS. 1-3 have teeth without so-called claws. However, small claws may be added without increase of tool cost and still improving the motor performance.

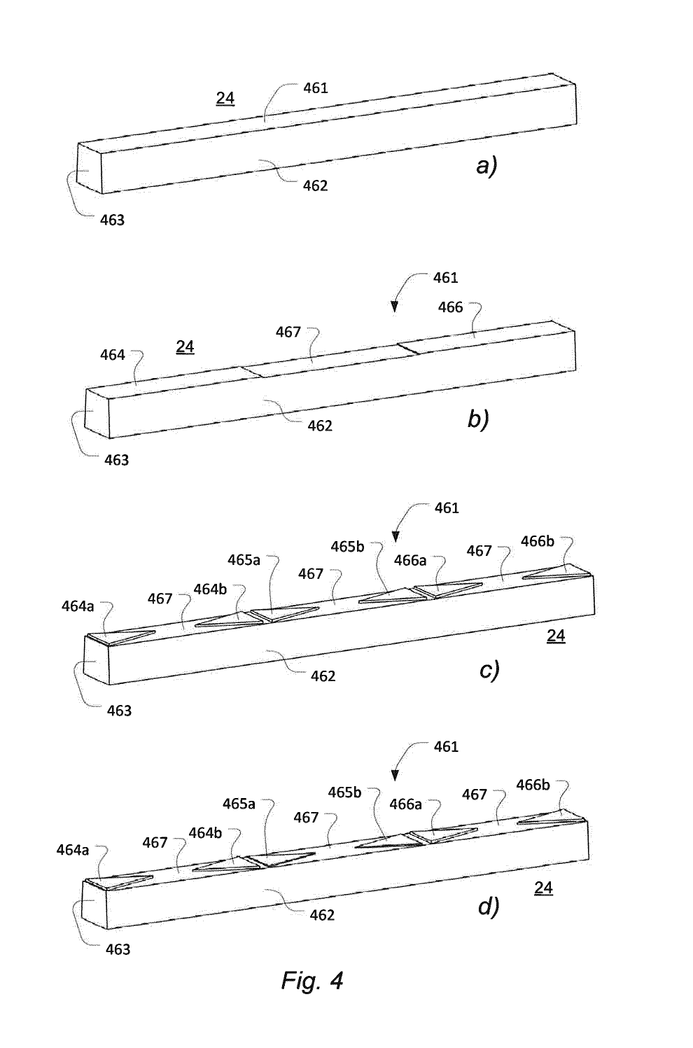

FIG. 4 shows examples of rotor pole pieces for a rotor of a modulated pole machine. Each of FIGS. 4a-d shows an example of a pole piece 24 for a rotor of an outer-rotor machine, e.g. for the rotor 30 of the machine shown in FIG. 3. It will be appreciated, however that pole pieces with similar features may also be provided for inner-rotor machines. Each pole piece 24 has the form of an elongated rod, elongated in the axial direction of the rotor. As can be seen from the end faces 463, the cross section of the pole piece is generally trapezoidal so as to provide gaps between adjacent pole pieces when the pole pieces are arranged into a cylindrical rotor structure as shown in FIG. 3, such that the gaps can accommodate rectilinear permanent magnets with rectangular cross-sections. It shall be appreciated, however, that the precise cross-sectional shape may vary; for example, the cross-sectional shape may be rectangular, trapezoidal, a section of a circle, etc.

The pole piece 24 has opposite side faces 462 providing respective interface surfaces to respective permanent magnets positioned adjacent to the pole piece in the alternating arrangement of pole pieces and permanent magnets in a rotor structure as the one on FIG. 3. The pole piece further has an interface surface 461 defining the direction facing the air gap between the rotor and the stator.

As mentioned above, the pole pieces of FIG. 4 may be for a rotor of a three-phase machine, e.g. as shown in FIG. 3. Accordingly, the pole piece may axially extend across all three phases of the three-phase machine such that pole piece functionally may be divided in three equally long sections, each section serving as a pole piece for one of the phases of a three-phase machine. Each section may thus have about ⅓ of the length of the entire pole piece. Corresponding considerations apply for other multi-phase machines.

The different examples of the pole pieces shown in FIG. 4 differ in how the interface surface 461 is shaped.

In the example of FIG. 4a, the interface surface 461 is generally flat, i.e. it may define a plane or a cylinder having a constant radial distance to the axis of the rotor.

In the examples 4b-d, the interface surface has one or more elevated portions and one or more low portions where the elevated portions are elevated or raised relative to the low portions, thus causing the radial distance between the different portions of the interface surface and the axis of the rotor to vary.

In particular, in the example of FIG. 4b, the interface surface 461 has two elevated portions 464 and 466, and a low or recessed portion 467. The elevated portions are proximal to the respective ends of the elongated pole piece while the low portion is located at the center of the elongated pole piece. Each portion axially extends about ⅓ of the length of the pole piece, corresponding to the axial extents of the respective phases of a three-phase machine. Accordingly, this embodiment results in a machine where the width of the air gap differs for the different phases. More particularly, the air gap for the central phase is larger (in the radial direction) than the air gap for the outer phases. The different width of the air gap for the different phases allows a reduction of the counter electromotive forces (“back-emf”) in a cost efficient manner.

The pole piece of FIG. 4c is also a pole piece for a rotor for a three-phase machine and, in particular, a machine having a stator where each phase comprises two circumferential rows of teeth protruding towards the rotor such that the tip of each tooth defines a respective interface surface to the air gap. The rows of teeth of each phase are axially spaced apart from each other leaving a gap between them in the form of an unbroken ring. An example of such a stator is shown in FIG. 3. The interface surface 461 of the pole piece of FIG. 4c has elevated portions 464a-b, 465a-b and 466a-b at the axial positions of the rows of teeth of the respective phases of the stator. In particular, elevated portions 464a-b correspond to the axial positions of the teeth of a first phase, elevated portions 465a-b correspond to the axial positions of the teeth of a second phase, and elevated portions 466a-b correspond to the axial positions of the teeth of a third phase. The elevated portions each have a uniform surface, which may be a plane or part of a cylindrical surface; in the latter case all points on each elevated portion have the same radial distance from the axis of the rotor. The remaining part of the interface surface is uniform and constitutes a low portion 467. The axial positions of the low portion thus correspond to the axial positions of the coils and the gaps between phases. The low portion may be a plane or a cylindrical, i.e. in the latter case all points of the low portion have the same radial distance from the axis of the rotor. In the case of an outer rotor structure the radial distance between the elevated surface portions and the rotor axis is smaller than the radial distance between the low portion and the rotor axis. In case of an inner-rotor structure the radial distance between the elevated surface portions and the rotor axis is larger than the radial distance between the low portion and the rotor axis.

Each of the elevated portions has an axial extent corresponding to (e.g. substantially equal to) the axial extent of the teeth of the corresponding stator structure. Each of the elevated portions has a width (measured in the circumferential direction of the rotor) that varies along the axial direction. In particular, each elevated portion has a narrow end proximal to the location of the stator winding, i.e. proximal to the gap between respective rows of teeth of a stator phase, and a wide end, wider than the narrow end, pointing away from the winding. Hence, when the pole piece passes a stator tooth during operation of the electrical machine, the average width of the air gap initially decreases until it reaches a minimum when the elevated portion and the stator tooth are perfectly aligned. During continued rotation of the rotor, the average width of the air gap increases again. Here the width of the air gap is measured as the shortest distance between a point on the interface surface of the stator tooth and the interface surface of the rotor. The average width of the air gap is averaged over all points on an axial straight line extending across the interface surface of the stator tooth.

In the example of FIG. 4c the elevated portions have the form of a triangle, in particular an isosceles triangle. However, in alternative embodiments the elevated portions may have different shapes.

In the example of FIG. 4c, all elevated portions have the same height relative to the low portion. In particular, all points of all elevated portions have the same radial distance from the rotor axis. However, in some embodiments the height of the elevated portions relative to the low portion and/or their respective distance from the rotor axis may vary, as is e.g. illustrated in FIG. 4d.

FIG. 4d shows an example of a rotor pole piece similar to the rotor pole piece of FIG. 4c, i.e. a rotor pole piece having multiple elevated portions at the axial locations of respective rows of teeth of the stator. However, in the example of FIG. 4d, the elevated portions have different heights. In particular, the elevated portions 465a and 465b, corresponding to the central phase of a three-phase machine, are less elevated than the remaining elevated portions that correspond to the outer phases of a three-phase machine. In the case of an outer-rotor machine, the distance between the elevated surface portions 465a and 465b and the rotor axis is larger than the corresponding distance between the other elevated portions and the rotor axis.

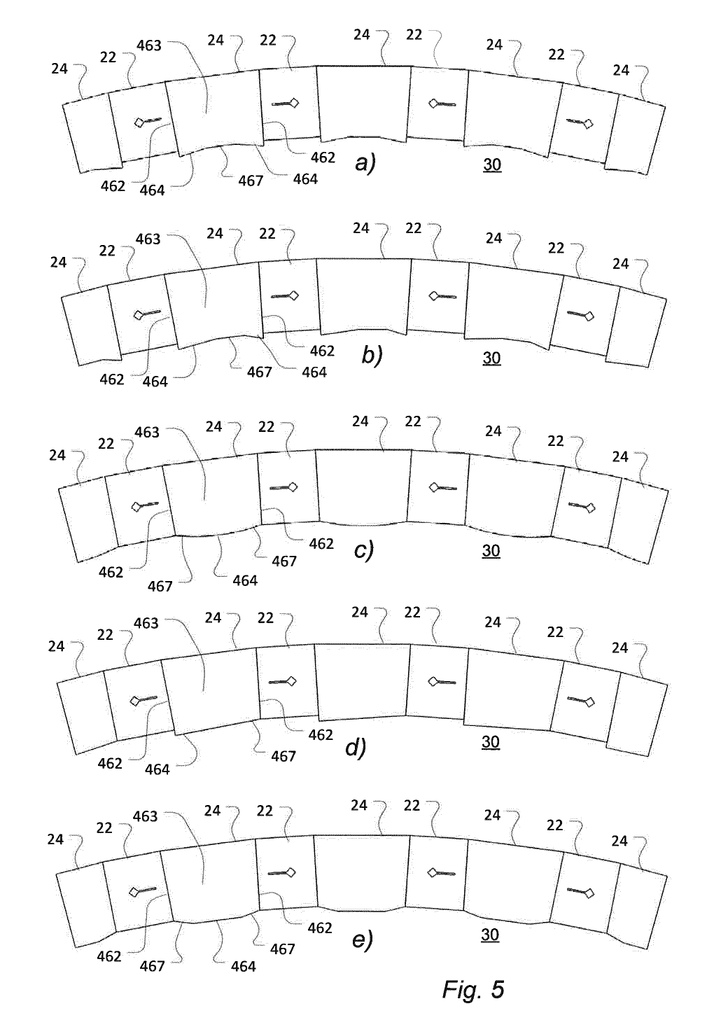

FIG. 5 shows side views of parts of examples of rotors for a modulated pole machine.

Each rotor comprises permanent magnets 22 and rotor pole pieces 24 that are arranged alternatingly in the circumferential direction of the rotor so as to form a cylindrical rotor structure. Hence, each rotor pole piece 24 has two adjacent permanent magnets 22, and each permanent magnet has two adjacent rotor pole pieces 24. The permanent magnets are in contact with the side faces 462 of the rotor pole pieces. To this end, in the example of FIG. 5, the permanent magnets 22 are rectilinear while the pole pieces are rods having a generally trapezoid-shaped cross section where the side faces are slightly slanted. The permanent magnets are magnetised in the circumferential directions as indicated by arrows in FIG. 5. The permanent magnets are magnetised in alternating orientation of the magnetic field vector so as to cause the magnetic flux to either enter a pole piece from both sides through the side faces 464 of the rotor pole piece or the exit the pole piece towards both circumferential directions through the side faces of the rotor pole piece.

The interface surfaces of the rotor pole pieces are profiled, i.e. different portions of the interface surface have different radial distances from the axis of the rotor. The interface surface has elevated portions 464 and low portions 467, where the elevated portions are elevated relative to the low portions.

The examples of FIG. 5a-e show rotors with pole pieces having different cross-sectional shapes. Some rotor pole pieces have convex interface surfaces while others have concave interface surfaces. In some examples the elevated portions have a uniform radial distance from the rotor axis while in other examples, the elevated portions have a varying radial distance from the rotor axis. The cross-sectional shape may be uniform or vary across the axial length of the pole piece. For example the cross-sectional shape may alternate between profiled and non-profiled portions and/or between differently profiled portions.

In the example of FIG. 5a, the pole pieces have a central low portion 467 and the edges of the pole pieces facing the adjacent permanent magnets are elevated and form a slanted surface portion extending from the low portion towards the respective edges of the pole pieces. Hence, in this example, the permanent magnets are slightly recessed relative to the immediately adjacent parts of the neighbouring pole pieces.

The example of FIG. 5b is similar to the example of FIG. 5a. However, while the cross section of the pole pieces of FIG. 5a are symmetric around the centre of the pole pieces, the cross section of the pole pieces of FIG. 5b are slightly asymmetric, i.e. the low portion extends more towards one of the permanent magnets than towards the other and one of the elevated surfaces is slanted more steeply than the other elevated surface.

FIG. 5c shows an example of a rotor where the interface surface of the pole pieces is curved outward, i.e. they have an elevated portion at its centre and low portions towards the edges formed with the side faces 462. The interface surface ends flush with the adjacent permanent magnets at the edges formed with the side faces of the pole pieces. During operation of the machine, the width of the air gap thus gradually decreases when a rotor pole piece approaches a tooth until it reaches a minimum when the rotor pole piece is aligned with the tooth and subsequently gradually increases again.

FIG. 5d shows an example of a rotor where the interface surface of each pole piece is slanted from the edge formed with one of its side faces towards the edge formed with the other side face, i.e. the interface surface has a low portion proximal to one edge of the interface surface and an elevated portion proximal to the opposite edge. The low portion of the interface surface ends flush with the edge of the adjacent permanent magnet, while the elevated portion at the opposite edge is elevated relative to the adjacent permanent magnet.

FIG. 5e shows an example of a rotor where the interface surface of each pole piece has an elevated central portion and slanted low portions that are slanted towards the edges of the pole piece towards the adjacent permanent magnets and that end flush with the adjacent permanent magnet.

For example, an asymmetric cross section of the interface surface, asymmetric relative to an axial centre line of the pole piece, may have the advantage of facilitating start of a single phase machine. Examples of such an asymmetric surface are shown in FIGS. 5b and 5d.

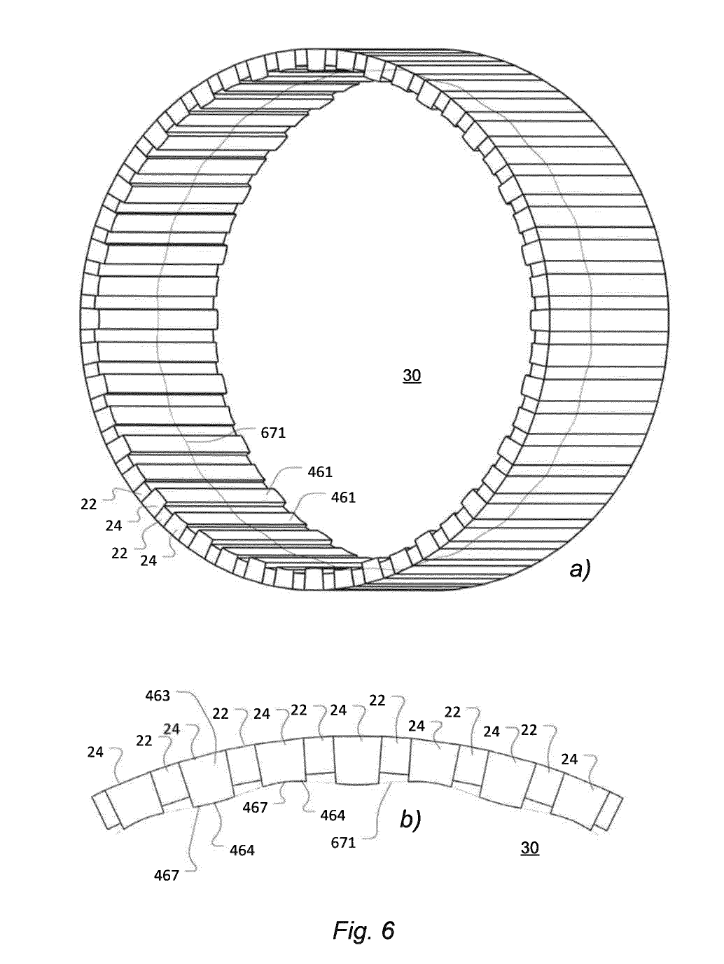

In the above examples, all pole pieces of the rotor are identical. However, in alternative embodiments, the interface surfaces of the pole pieces of a rotor may vary. An example of such an embodiment will now be described with reference to FIG. 6.

FIG. 6 shows another example of a rotor for a modulated pole machine. In particular, FIG. 6a shows a perspective view of the rotor structure, while FIG. 6b shows a side view of a part of the rotor. The rotor of FIG. 6 is similar to the rotor of FIG. 5 and comprises permanent magnets 22 and pole pieces arranged alternatingly so as to form a cylindrical rotor structure, all as described above. However, in the example of FIG. 6, the interface surfaces 461 of the pole pieces are not all identical. In the example of FIG. 6, the interface surfaces of the pole pieces are alternatingly curved outward and inward, i.e. the pole pieces with inwardly curved interface surface have a low portion at their centre and elevated portions at their respective edges, while the pole pieces with outwardly curved interface surface have an elevated portion at their centre and low portions proximal towards their edges. In both cases, however, the edge portions of the pole pieces are elevated compared to the side faces of their respective adjacent permanent magnets, i.e. the permanent magnets are recessed between adjacent pole pieces.

The interface surfaces are curved such that they all touch a closed curve 671 surrounding the rotor axis and following the surface of the cylindrical structure defining the air gap. The curve 671 defines a periodically varying radius as a function of an arc along the cylindrical surface defining the air gap. In the example of FIG. 6, the periodic function has a period equal to twice the pitch distance between pole pieces. In the example of FIG. 6, each interface surface touches the curve 671 at each point across its circumferential width. Consequently, the interface surfaces of the rotor pole pieces may be shaped such that the interface surfaces of the rotor pole pieces together approximate a periodic curve along the circumference of the rotor. This allows the rotor to be shaped so as to compensate for one or more harmonics of the cogging torque.

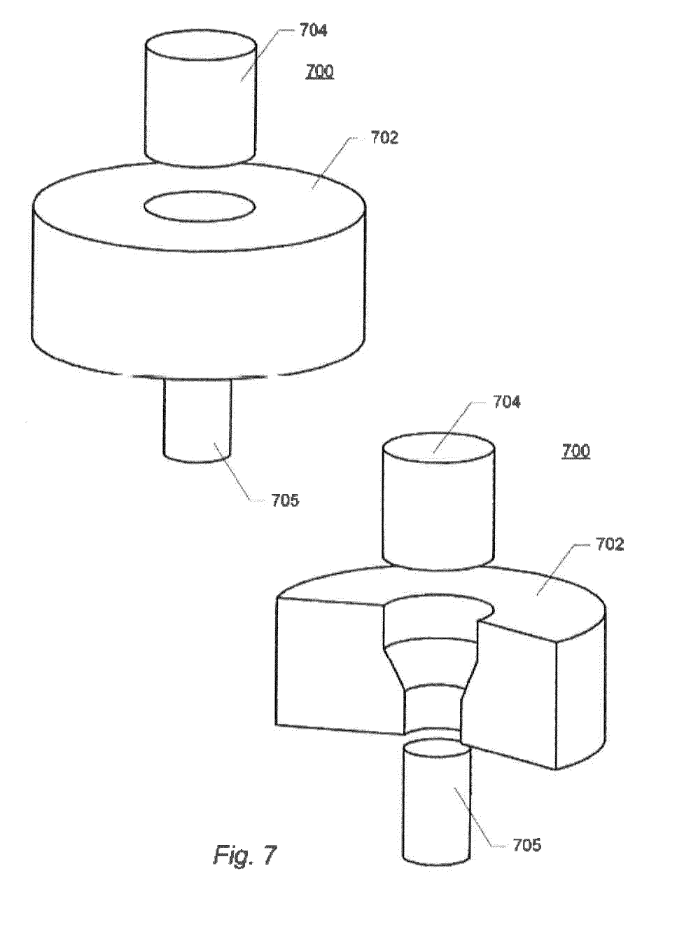

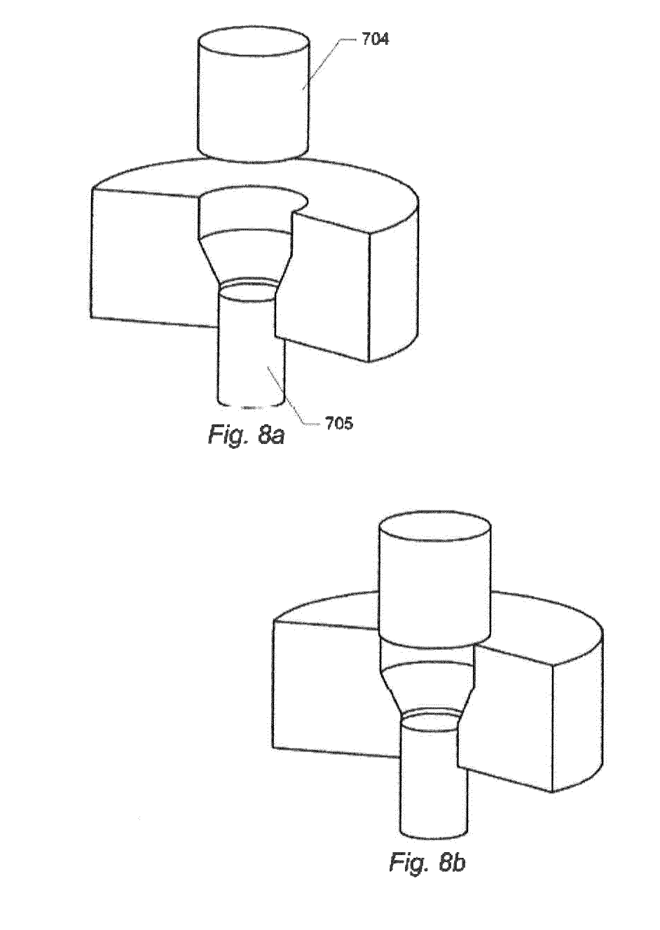

Embodiments of the rotor pole pieces and the stator core sections described herein may be efficiently manufactured and shaped through consolidation of metal powders within the P/M technology. An example of such method is the well-established technique for producing components out of metal powder using a tool and a press as illustrated by FIGS. 7-8.

FIG. 7 schematically illustrates a tool for pressing a soft magnetic component made from soft magnetic powder. In particular, FIG. 7a shows a pressing tool with a die 702, a single upper punch 704 and a single lower punch 705. FIG. 7b shows a cut view of the tool of FIG. 7a.

For ease of presentation, the process will be illustrated with reference to a simple component 803. However, it will be appreciated that the process and tool described in the following is well-suited for manufacturing embodiments of the pole pieces and the stator core sections described herein. The P/M process comprises filling a die 702 with metal powder 703 followed by a pressing using a number of punches 704 and 705. The pressing is followed by a sintering at high temperature (e.g. in the region of 1000° C.) or a heat treatment at lower temperature (e.g. up to approximately 650° C.). The tool, generally designated 700, may comprise a die 702 and at least one upper and/or one lower punch 704 and 705, respectively. The technology may be used for large scale production of high quality metal components. The MPM type of electrical machine is very well suited for utilizing the benefits of the P/M technology. For making electrical motors using P/M, the powder may be made out of electrically insulted iron powder called soft magnetic powder as described above.

In order to produce the pole pieces and stator core sections as described herein, the tool die 702 may be specifically adapted to have a so-called called ‘shaped die’ geometry, a technique known as such in the art. In embodiments of the tool only the die 702 that is shaping the tooth. The exact shape of the die depends on the actual component to be manufactured.

FIG. 8 illustrates the pressing process using the tool of FIG. 7.

FIG. 8a illustrates the tool in a powder filling position where the lower punch 705 is withdrawn from the die but still blocking the bottom opening of the die, while the upper punch is withdrawn from the die leaving the top opening of the die unobstructed allowing powder to be inserted through the top opening. FIG. 8b shows the closed die after completion of the filling process (the powder is not shown in FIG. 8b for clarity). FIG. 8c shows the closed die including the powder 703. FIG. 8d shows the tool with the pressed component, i.e. where both the bottom and the top punches have been inserted into the die so as to compact the powder in the shaped portion of the die. FIG. 8e shows the component ejection step where the punches are moved upwards so as to eject the component 803 from the die. FIG. 8f shows the ejected component 803.

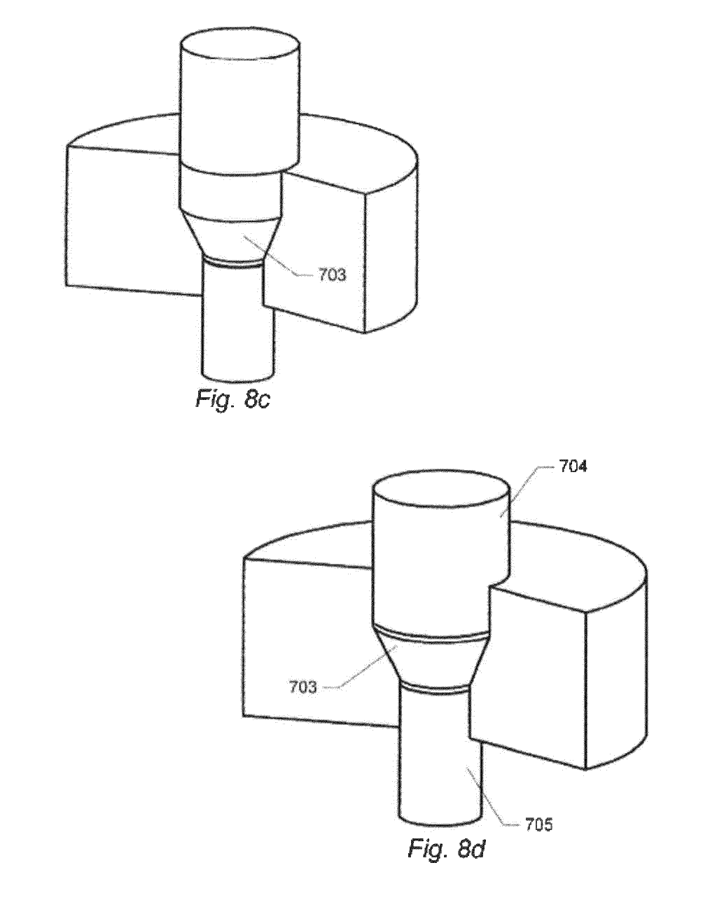

The reduction of cogging torque by shaping the rotor pole pieces as described herein may be analyzed using Finite Element Analysis (FEA) combined with Fast Fourier Transform analysis (FFT). FIG. 9 shows the cogging torque as a function of angle for a modulated pole machine as shown in FIG. 3. Curve 981 shows the cogging torque for a machine with pole pieces as shown in FIG. 4a. Curve 982 shows the cogging torque for a machine with pole pieces as shown in FIG. 4a and with shaped teeth as described in co-pending international patent application PCT/EP2011/073347. Curve 983 shows the cogging torque for a machine with pole pieces as shown in FIG. 4c while the stator teeth have a flat surface. Hence, it can be seen from FIG. 9 that a considerable reduction of the cogging torque can be achieved by shaping of the interface surface of the stator teeth or of the rotor pole pieces. Furthermore the reduction achieved by shaping the stator teeth and by shaping the rotor pole pieces is of comparable magnitude. However, the pole pieces have a considerably simpler geometry and the interface surface of the pole piece face the top punch of a shaping tool, the shaping of elevated portions of limited height can be done without significant increase of the complexity of the manufacturing process or tools.

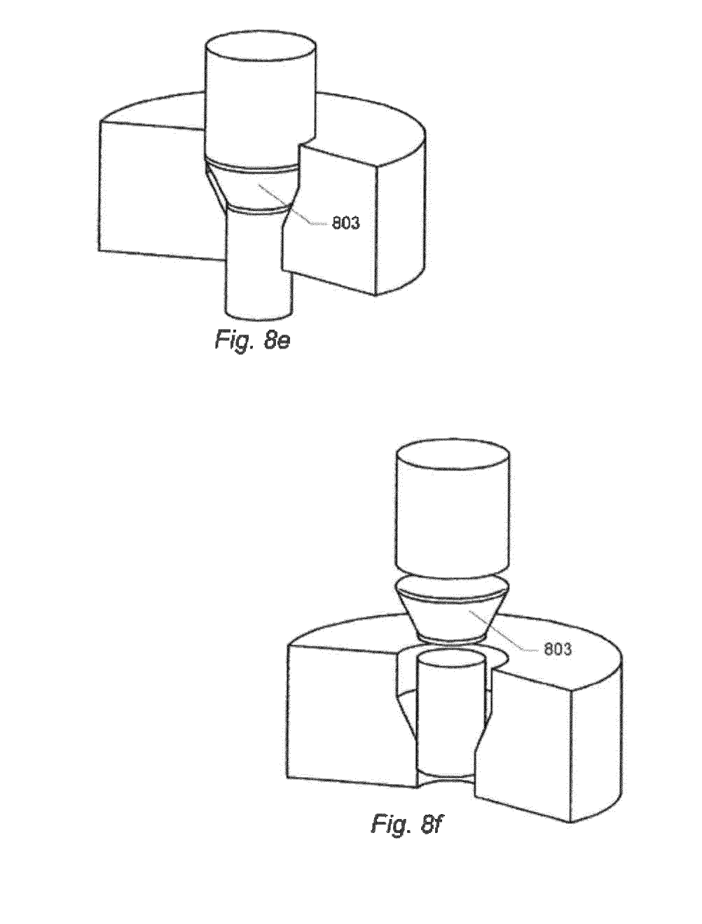

FIG. 10 shows a 3-phase modulated pole machine comprising a stator with 3 sets of stator component pairs, each holding one circumferential winding. The machine of FIG. 10 is similar to the machine of FIG. 3 but where the pole pieces have different widths measured in the circumferential direction of the rotor. In particular, the rotor comprises a first set of narrow pole pieces 24a and a second set of wider pole pieces 24b that have a larger width than the pole pieces of the first set. The pole pieces of the first and second set are arranged alternatingly along the circumference of the machine. It will be appreciated that the pole pieces may have flat/constant-radius interface surfaces or shaped/profiled interface surfaces as described herein. It will further be understood that a rotor may comprise pole pieces of more than two different widths.

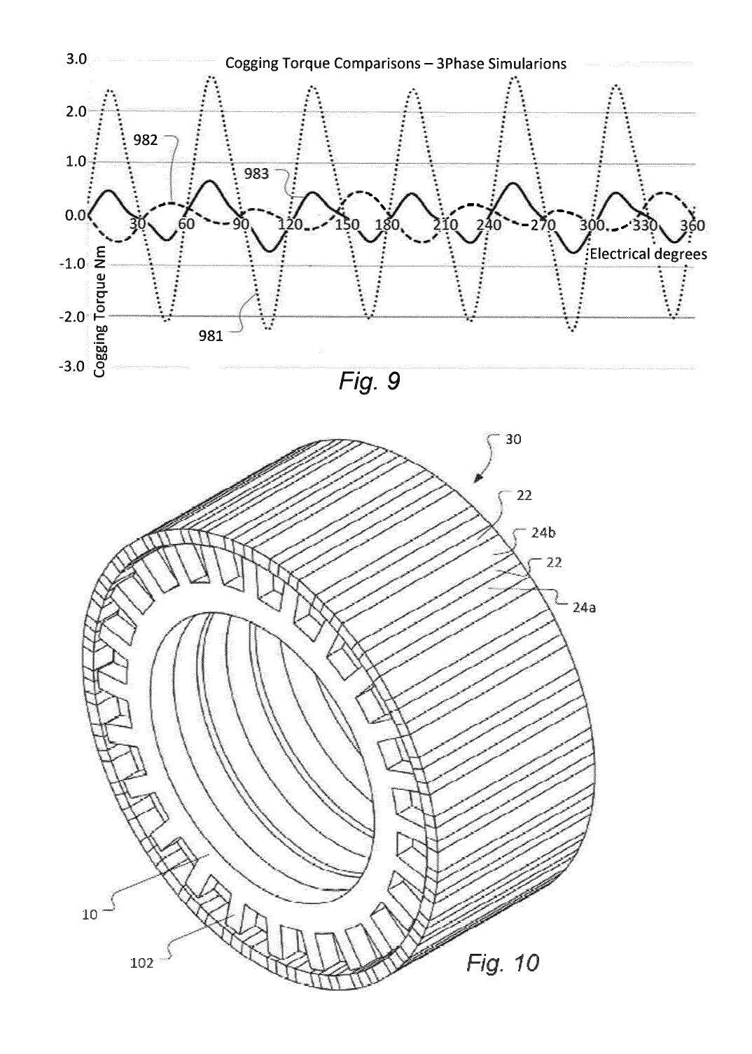

FIG. 11 shows further examples of rotor pole pieces for a rotor of a modulated pole machine. Each of FIGS. 11a-b shows an example of a pole piece 24 similar to the pole piece shown in FIG. 4c, i.e. a pole piece having the form of an elongated rod, elongated in the axial direction of the rotor and having a cross section that is generally trapezoidal. The interface surface comprises low portions 467 and elevated portions 464. In the example of FIG. 11a the elevated portions have a rectangular shape and, in the example of FIG. 11 b, the elevated portions have the form of parallelograms.

Although some embodiments have been described and shown in detail, the invention is not restricted to them, but may also be embodied in other ways within the scope of the subject matter defined in the following claims. In particular, it is to be understood that other embodiments may be utilised, and that structural and functional modifications may be made without departing from the scope of the present invention.

Embodiments of the invention disclosed herein may be used for a direct wheel drive motor for an electric-bicycle or other electrically driven vehicle, in particular a light-weight vehicle. Such applications may impose demands on high torque, relatively low speed and low cost. These demands may be fulfilled by a motor with a relatively high pole number in a compact geometry using a small volume of permanent magnets and wire coils to fit and to meet cost demands by the enhanced rotor assembly routine.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A rotor for a modulated pole machine, the modulated pole machine comprising a stator, the rotor, and an active gap between respective interface surfaces of the rotor and the stator for communicating magnetic flux between the stator and the rotor, the rotor being adapted to rotate relative to the stator around an axis of the rotor, and the rotor comprising a plurality of permanent magnets separated from each other in the circumferential direction by pole pieces;
wherein each pole piece comprises an interface surface facing the active gap,
wherein the interface surface of one or more of the pole pieces comprises different surface portions having different respective radial distances from the axis.

2. A rotor according to claim 1, wherein the interface surface comprises an elevated portion having a first distance to the axis and a low portion having a second distance to the axis, different from the first distance, and where the elevated portion is elevated from the low portion relative to a centre of the pole piece.

3. A rotor according to claim 2, where the elevated portion has a width in the circumferential direction of the rotor, and wherein the width varies along the axial direction of the rotor.

4. A rotor according to claim 2, wherein the elevated portion has a height relative to the low portion which height varies along the circumferential direction of the rotor.

5. A rotor according to claim 2, wherein one or more of the pole pieces each comprises at least two outer elevated portions and a central elevated portion seen in the axial direction of the rotor, and wherein the outer elevated portions are elevated from the central elevated portion.

6. A rotor according to claim 2, wherein the elevated portion has a uniform radial distance from the axis.

7. A rotor according to claim 1, wherein the radial distance between the interface surface of a pole piece and the axis of the rotor varies in the circumferential direction.

8. A rotor according claim 1, wherein a radial-circumferential cross section of the interface surfaces of the pole pieces follows a curve having a periodically varying radial distance from the centre.

9. A rotor according to claim 1, comprising:
at least a first subset of pole pieces each having a first width measured in the circumferential direction of the rotor; and
a second subset of pole pieces each having a second width measured in the circumferential direction of the rotor, different from the first width.

10. A rotor for a modulated pole machine, the modulated pole machine comprising a stator, the rotor, and an active gap between respective interface surfaces of the rotor and the stator for communicating magnetic flux between the stator and the rotor, the rotor being adapted to rotate relative to the stator around an axis of the rotor, and the rotor comprising a plurality of permanent magnets separated from each other in the circumferential direction by pole pieces;
wherein the rotor comprises:
at least a first subset of pole pieces each having a first width measured in the circumferential direction of the rotor; and
a second subset of pole pieces each having a second width measured in the circumferential direction of the rotor, different from the first width.

11. A modulated pole machine comprising a stator, a rotor as defined in claim 1, and an active gap between respective interface surfaces of the rotor and the stator for communicating magnetic flux between the stator and the rotor.

12. A modulated pole machine according to claim 11 wherein a distance between the interface surface of each of the pole pieces and the interface surface of the stator varies when the pole piece moves across the interface surface of the stator.

13. A modulated pole machine according to claim 11, wherein the modulated pole machine is a multi-phase machine having two outer phases and one or more central phases;
wherein the portions of the interface surfaces at positions of the outer phases are elevated from the portions of the interface surface at positions of the central phase.

14. A modulated pole machine according to claim 11, wherein the stator comprises a first stator core section; wherein the first stator core section comprises a stator core back from which a plurality of teeth extend, each tooth extending in a respective first direction defining a direction towards the rotor, the teeth being arranged along the circumferential direction, each tooth having at least one interface surface facing the active gap.

15. A modulated pole machine according to claim 14, wherein the stator comprises a second, like stator core section arranged side by side to the first stator core section in the transverse direction, wherein the teeth of the first and second stator core sections are displaced relative to each other in the direction of motion; and
wherein the radius of curvature of said teeth of the first stator core section increases in the direction towards the second stator core section.

16. A modulated pole machine according to claim 11, wherein the modulated pole machine is a multi-phase machine having two outer phases and one or more central phases, each phase comprising a coil axially sandwiched between respective circumferential rows of radially protruding teeth;
wherein the portions of the interface surface of the rotor pole pieces at axial positions of the teeth are elevated from the portions of the interface surface at axial positions of the coils.
